(19) United States
(12) Patent Application Publication
(10) Pub. No.: US 2026/0021899 A1
(43) Pub. Date: Jan. 22, 2026

(54) DEVICES, SYSTEMS, AIRCRAFT AND METHODS FOR POWERING THE SAME

(71) Applicant: Joseph Covelli, River Falls, WI (US)

(72) Inventors: KEITH LEMIRE, Afton, MN (US); JOSEPH COVELLI, River Falls, WI (US)

(73) Assignee: Joseph Covelli, River Falls, WI (US)

(21) Appl. No.: 18/775,143

(22) Filed: Jul. 17, 2024

(51) Int. Cl. B64D 35/02; F16F 15/315; F16H 57/00

(52) U.S. Cl. CPC B64D 35/02; F16H 57/0006; F16F 15/315

(57) ABSTRACT

Devices, systems, and methods for powering an output drive of a gearbox, including in some applications powering a propeller of a gyroplane, including a flywheel hub connected to a flywheel, connected to a drive shaft of an engine, and connected to a rubber coupling of a gearbox to drive an output shaft of the gearbox such that activation of the engine powers a propeller driven by the output shaft, and in aspects includes an adapter having a flywheel contained in a casing which casing is connected to the engine at one side of the casing and to the gearbox at an opposite side of the casing. In aspects the system accommodates use of a 2-cylinder, 4-stroke engine to power a gyroplane, lightweight aircraft, airboat, or other machinery.

### BACKGROUND OF THE INVENTION

Drive systems which include an engine and gearbox are used to power a variety of equipment, devices, vehicles, aircraft and machinery. Many drive systems use a flywheel to accommodate efficient running of the system. A gyroplane, or autogyro, is one type of machine or aircraft which includes a drive system having speed reduction gears integrated in the engine casing or separately in a gearbox to power the aircraft. A gyroplane is a class of aircraft or rotorcraft that uses an unpowered rotor in free rotation to develop lift. Similar to a helicopter rotor in appearance, the gyroplane's rotor blade uses air flowing upward across the blade to make it rotate. While the rotor blade is unpowered, forward thrust of the aircraft is provided independently by an engine-driven propeller. Rotation of the engine-driven propeller causes the aircraft to move forward, while the unpowered rotor freely rotates to generate lift the same way as a glider's wing, by changing the angle of the air as the air moves upward and backward relative to the rotor blade. Many modern gyroplanes use a pusher-propeller, where the engine and propeller are located behind the pilot and behind the mast of the rotor. A driveshaft extending from the engine is connected to the speed reduction gearbox, where the gearbox is further connected to the propeller to power the aircraft forward. In some applications a 2-cylinder, 2-stroke type of engine or a 4-cylinder, 4-stroke type of engine is used to power the engine-driven propeller.

### SUMMARY OF THE INVENTION

An engine used to power a gyroplane must be reliable, powerful, lightweight and preferably compact. While a 2-cylinder 2-stroke type of engine has been used regularly in conjunction with traditional gearboxes to power a propeller of gyroplanes, such engine is not always available, and/or such gearboxes are not always available or have been discontinued. There are some engines for use in other areas which have proven reliable and powerful for their purposes, and even lightweight and/or compact engines such as those used for utility vehicles (UTVs) have become commonplace. However, heretofore such engines have simply been unworkable for powering the propeller of a gyroplane or other lightweight aircraft or other machinery.

Applicant discovered that such engines, like a standard UTV engine (i.e., a 2-cylinder, 4-stroke engine), when coupled with a gearbox, would not power the propeller due to the engine simply failing to operate. When directly coupled with a Rotax brand Reduction Gearbox E, for instance, the engine failed due to aggressive knocking and vibration. Attempting to further operate the engine would have led to destruction of the engine. Applicant recognized that directly connecting the gearbox to the 2-cylinder, 4-stroke engine was not viable. Applicant recognized that a flywheel traditionally associated with the reduction gearbox and/or the engine was too small and unworkable for solving the vibration or oscillation problem (or problems due to imbalanced moments of inertia). Applicant solved the problem by utilizing a specially designed flywheel of large mass and inertia (having large diameter) to dampen the forces (or balance moments of inertia) internal to the engine and the reduction gearbox and allow for efficient driving of the gearbox without harm to the engine. An additional problem was to accommodate use or positioning of the large profile flywheel in conjunction with the gearbox and 2-cylinder, 4-stroke engine. Traditional engines and gearboxes would not accommodate use of such a large diameter flywheel. Applicant solved this problem by creating an adapter having a separate casing to house the larger profiled flywheel, together with other components such as a flywheel hub which connects the flywheel to both the gearbox components and the drive shaft of the engine. The adapter is configured to connect between the engine and the gearbox, and is able to connect with off-the shelf devices such as an unmodified engine block and an unmodified gearbox casing. Applicant also recognized that positioning the adapter between the gearbox and the engine posed yet another problem. While the rotational forces or torsional load from the gearbox to the propeller were sufficiently accommodated via the flywheel hub of the adapter, the adapter was configured to also handle the approximately 400 pounds of thrust load due to the spinning propeller. While the propeller and gearbox exert an overhang load on the adapter, there is also the thrust load imparted on the adapter due to the spinning propeller and from normal aircraft banking and maneuvers during flight. Particularly, the entire thrust load of the aircraft is received at the casing of the adapter. The casing of the adapter is configured such that the thrust load is transferred around the flywheel to the engine block. Applicant minimized the thrust load problem by configuring the adapter with a structurally reinforced casing portion to handle the thrust loads. Applicant recognized and solved the many problems at least in part by creating a larger diameter flywheel to properly dampen the oscillations or vibrations (or balance in the moments of inertia) caused by using a 2-cylinder, 4-stroke engine in combination with a gearbox to power a propeller, arranging the large flywheel within a separate casing positioned between the gearbox and the engine, and configuring the adapter with a reinforced casing to handle the thrust loads caused by the spinning propeller and use of the aircraft or other machinery. Without the adapter and these modifications, a typical 2-cylinder, 4-stroke UTV engine is not workable for aviation. The adapter may also be used in conjunction with various engines and gearboxes for use in other applications.

In one aspect, the invention includes an adapter for connecting an engine with a gearbox, including a casing having a first casing portion connected to a second casing portion and defining a flywheel cavity, a flywheel contained within the flywheel cavity. The second casing portion is configured to connect to the engine and the first casing portion is configured to connect to the gearbox.

In further aspects, a flywheel hub is connected to the flywheel and extends outward from a gearbox-side opening of the first casing portion. In aspects, the adapter is used to connect an engine and a gearbox to power a gyroplane or other lightweight aircraft or other machinery.

In a further aspect, the invention includes a system for powering a driven shaft, including an engine having an engine drive shaft, a flywheel, a gearbox having an output drive shaft configured to power the driven shaft, the gearbox including a rubber coupling, and a flywheel hub connected to the flywheel, the flywheel hub connected to the rubber coupling, and the flywheel hub connected to the engine drive shaft, where activation of the engine powers the driven shaft.

In a further aspect, the invention includes a drive system having an engine having an engine block, a gearbox having an output drive powered by the engine, and an adapter having a first casing portion connected to a second casing portion and defining a flywheel cavity, a flywheel contained within the flywheel cavity, the first casing portion connected to the gearbox, the second casing portion connected to the engine, the flywheel having a diameter greater than a total height of the engine block. Activation of the engine powers the output drive. In aspects a flywheel hub is connected to the flywheel and extends outward from a gearbox-side opening of the first casing portion. In further aspects the flywheel hub is connected to an engine drive shaft extending from the engine into the adapter and is further connected to a rubber coupling within the gearbox.

In a further aspect, the invention includes a drive system having an engine, a gearbox having a driven gear powered by the engine, the driven gear having a maximum diameter, and an adapter having a first casing portion connected to a second casing portion and defining a flywheel cavity, a flywheel contained within the flywheel cavity, the first casing portion connected to the gearbox, the second casing portion connected to the engine, the flywheel having a diameter greater than the maximum diameter of the driven gear. Activation of the engine powers the driven gear. In aspects a flywheel hub is connected to the flywheel and extends outward from a gearbox-side opening of the first casing portion.

In a further aspect, the invention includes an adapter for connecting an engine with a gearbox, the adapter including a casing having a first casing portion connected to a second casing portion and defining a flywheel cavity, and a flywheel contained within the flywheel cavity, where the second casing portion is configured to connect to the engine and the first casing portion is configured to connect to the gearbox. In aspects a flywheel hub is connected to the flywheel and extends outward from a gearbox-side of the first casing portion.

In a further aspect, the invention includes a machine or apparatus powered by a 2-cylinder, 4-stroke engine. Applicant created a solution to the above-mentioned problems by providing a special flywheel and adapter positioned between the 2-cylinder, 4-stroke type of engine and the gearbox which transfers the engine power to a drive mechanism of the machine or apparatus. In aspects, the machine or apparatus is a gyroplane or other lightweight aircraft, or other machinery, and the gearbox transfers the engine power to a propeller of the gyroplane or other aircraft or machinery.

In a further aspects, the invention includes a gyroplane having a 2-cylinder, 4-stroke engine coupled to a gearbox which powers a propeller of the gyroplane, such coupling including an adapter positioned between the engine and the gearbox. In one aspect, the adapter includes a flywheel having a large diameter, such as a flywheel diameter of 8 to 16 inches, and in some aspects a flywheel diameter of 12 inches.

In a further aspect the invention include a method for powering a driven shaft of an apparatus, the method including providing a driven shaft driven by an output drive of a gearbox, a coupling flange connected to the output drive, a rubber coupling connected to the coupling flange, a flywheel hub connected to the rubber coupling, the flywheel hub connected to a flywheel and to an output shaft of an engine, and activating the engine to power the driven shaft. In some aspects the method includes the output drive activating a propeller gear to drive a propeller of the apparatus.

In a further aspect the invention includes a reinforced adapter and a reinforced casing portion where the casing portion includes a wall bounded by an edge wall which outlines a perimeter of the casing portion, a series of nodes which provide increased structural support about the perimeter edge wall, at least one footing positioned at a perimeter of a central opening of the wall, and a series of ribs connected between the notes and the footing to provide structural support to the casing portion and adapter. In aspects the ribs are oriented vertically and horizontally with angled ribs positioned therebetween. The reinforced casing portion mates with another casing portion to define a flywheel cavity configured to receive a flywheel and a flywheel hub which hub partially extends outward from the reinforced casing portion.

The above partial summary of the present invention is not intended to describe each illustrated embodiment, aspect, or every implementation of the present invention. The figures and detailed description and claims that follow more particularly exemplify these and other embodiments and further aspects of the invention.

### BRIEF DESCRIPTION OF THE DRAWINGS

FIG. 1 is a partial perspective view of an aircraft having an engine system and in accordance with aircraft, systems, and adapter aspects of the invention.

FIG. 2 is a front perspective view of the engine system and adapter of FIG. 1, with portions removed for clarity.

FIG. 3 is a section view taken along line 3-3 of FIG. 2.

FIG. 4 is a perspective view of an adapter in accordance with aspects of the invention.

FIG. 5 is an exploded perspective view of the adapter of FIG. 4.

FIG. 6 is a perspective view of the engine system of FIG. 3

FIG. 7 is a further perspective view of the engine system of FIG. 3.

FIG. 8 is an exploded view of the engine system of FIG. 6.

FIG. 9 is an exploded view of the engine system of FIG. 7.

FIG. 10 is an exploded partial perspective view of the engine system and adapter of FIG. 2.

FIG. 11 is an exploded partial perspective view of the engine system and adapter of FIG. 2.

FIG. 12 is a front view of a further aspect of the invention and casing component of the engine system and adapter of FIG. 2.

While the invention is amenable to various modifications and alternative forms, specifics thereof have been shown by way of example in the drawings and will be described in detail. It should be understood, however, that the intention is not necessarily to limit the invention to the particular embodiments, aspects and features described. On the contrary, the intention is to cover all modifications, equivalents, and alternatives falling within the spirit and scope of the invention and as defined by the appended claims.

### DETAILED DESCRIPTION OF THE INVENTION

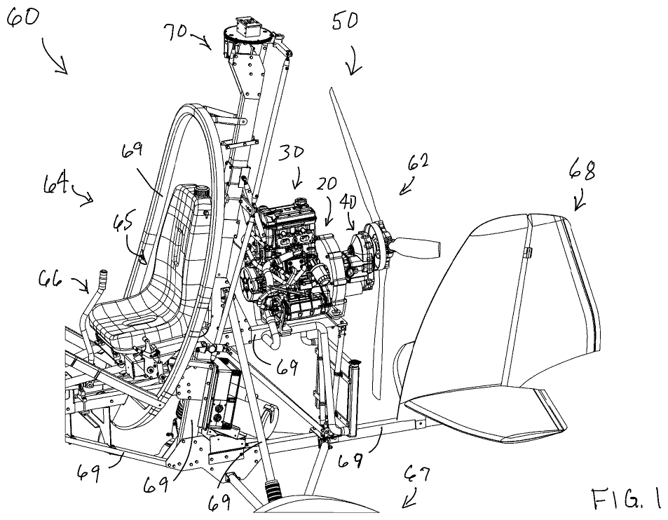

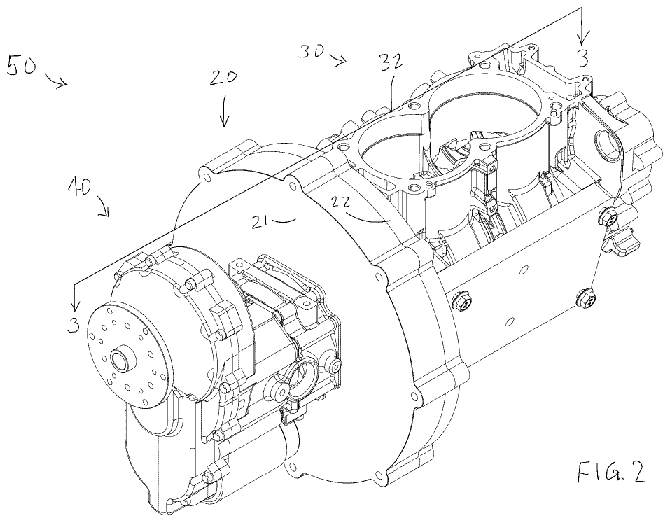

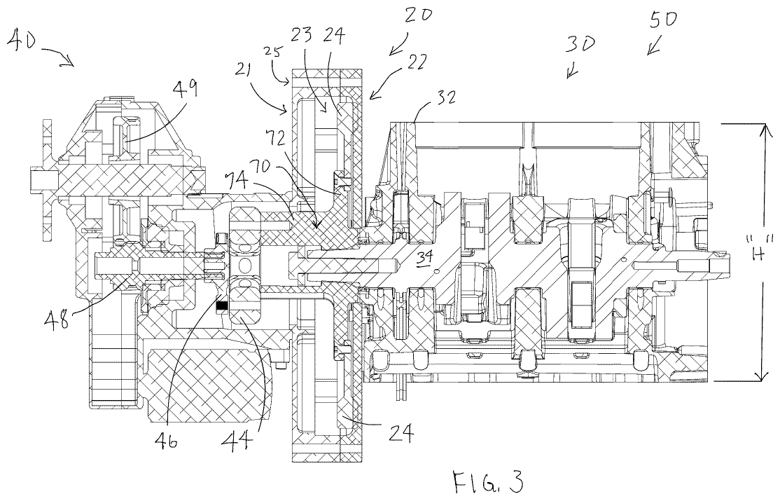

Referring to FIGS. 1-12, aspects of the devices, machines, systems, aircraft and methods of the invention are shown. In aspects the invention includes an aircraft 60, such as a gyroplane or other aircraft, powered by an engine system 50. Engine system 50 includes an engine 30 which powers a propeller 62. A spinning propeller 62 causes forward thrust to the aircraft 60. In aspects, the aircraft 60 includes a pilot section 64 having a seat 65, hand and foot controls 66 for operation of the aircraft 60, together with wheels 67, rudder/wing system 68, mast 70 and support members 69 for supporting the same. The mast 70 is configured to receive a rotor at a position above the pilot section 64. The engine 30 and mast 70 are positioned rearward the pilot section 64 and opposite the forward direction of travel. The rotor is unpowered and configured to freely rotate. The blades of the rotor rotate to generate lift the same way as a glider's wing, and by changing the angle of the air as the air moves upward and backward relative the blade. The blades of the rotor are angled so that the lift also accelerates the rotation rate of the blade until the rotor turns at a stable speed with the drag force and the thrust force in balance. The engine system 50 also includes a gearbox 40 and an adapter 20. The gearbox 40 and adapter 20 cooperate to transfer power from the engine 30 to the propeller 62. As shown in FIG. 2, the engine system 50 includes adapter 20 which is positioned between the engine 30 and the gearbox 40. FIG. 3 presents a cross-section view along line 3-3 of FIG. 2, and shows further features of a representative engine system 50 and adapter 20 aspects of the invention. The system and components of FIG. 2 through FIG. 12 may also be used to power different machines or devices, and are not limited to use only with aircraft. The systems and components may be used to power, for instance, an airboat or other propeller machinery, or machinery powered using a spinning drive shaft.

In one aspect engine 30 is a 2-cylinder, 4-stroke engine. An example of such an engine 30 is an engine used in a utility vehicle (UTV) such as with a Polaris brand or other UTV. Such engine 30 is ideal for utility vehicle applications given its small size and tremendous power output. While such engine has been traditionally used to power the drive system of a utility vehicle, which utility vehicles have a very heavy mass and are designed to travel at high speeds across rough terrain, heretofore such engine 30 has been unable to operate when combined directly with a gearbox and driving a propeller or driving a device of lesser mass such as aircraft 60. Accordingly, an adapter 20 is positioned between the engine 30 and gearbox 40 to allow operation and to drive the propeller 62. Adapter 20 dampens vibrations or smooths oscillations or remedies other aspects of the engine 30 to match smooth operation of gearbox 40. Aircraft 60 would not operate without adapter 20. It may be appreciated that the systems and components of the invention are not limited to use of 2-cylinder, 4-stroke engines, and other engines (and gearboxes) may utilize the adapter 20 and aspects presented herein.

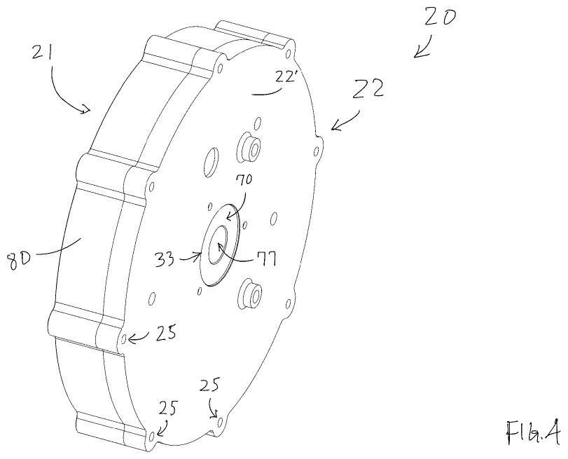

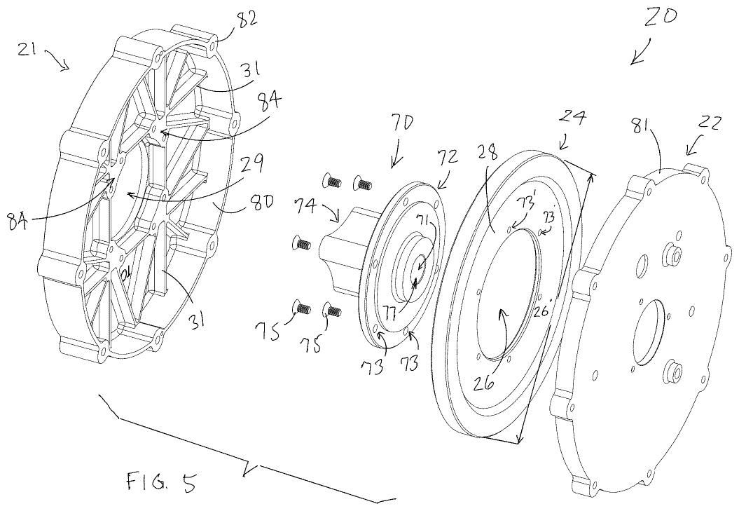

With reference to the drawings including FIG. 4 and FIG. 5, in one aspect of the invention, adapter 20 includes a casing having a first casing portion 21 and a second casing portion 22. Casing portions 21, 22 connect together and define a flywheel cavity 23 configured to receive flywheel 24. Casing portions may be connected together by fasteners such as bolts secured through fastener ports 25. The second casing portion 22 of adapter 20 connects to the engine 30, while the first casing portion 21 connects to the gearbox 40 by fasteners such as bolts or screws. Flywheel 24 is a generally disk-shaped member having a central opening 26. An outer rim section 27 of the flywheel 24 has a relatively wide profile compared to a field section 28, which rim section 27 provides a greater mass at the outward area of the flywheel 24. The flywheel 24 is made of metal, such as steel or other metal, and is specially designed (with selected profile and/or weight distribution) to exhibit a desired moment of inertia to dampen vibrations or oscillations (or better match the moments of inertia and problems associated with imbalance of moments of inertia) due to a large disparity in the respective inertias of the system. For instance, the total moment of inertia of the output side (propeller) is typically much greater than the moment of inertia of the input side (engine) due to the large diameter of the propeller. Once the propeller 62 begins to spin, the moment of inertia, or disparity of inertias, is further impacted. A large diameter flywheel 24 increases the moment of inertia of the input side (of the engine drive shaft 34) to better match the moment of inertia of the output side (spinning propeller 62). The flywheel 24 is dimensioned to better match the moment of inertia of the spinning propeller 62, thus allowing the engine 30 to operate, and to operate more efficiently. Without the larger flywheel 24 and associated larger moment of inertia, the engine 30 simply cannot overcome the imbalance in the system and otherwise fails to operate. In aspects, casing portion 21 includes strengthening ribs 31 for providing structural strength to casing 21, 22. Ribs 31 may be provided in various orientations to accommodate a desired strength characteristic, noting that casing 21, 22 at least in part supports the mass and stress of the gearbox 40 and the thrusts due to spinning propeller 62 and operation of the aircraft 60. Further discussion regarding the structural strength of adapter 20 is presented below.

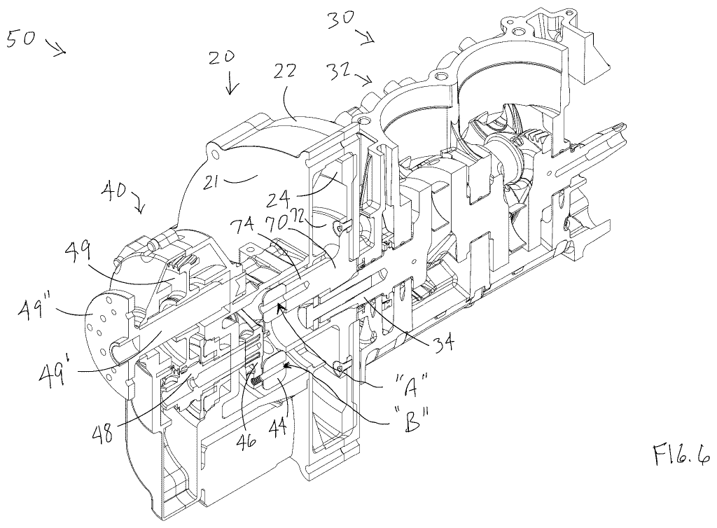

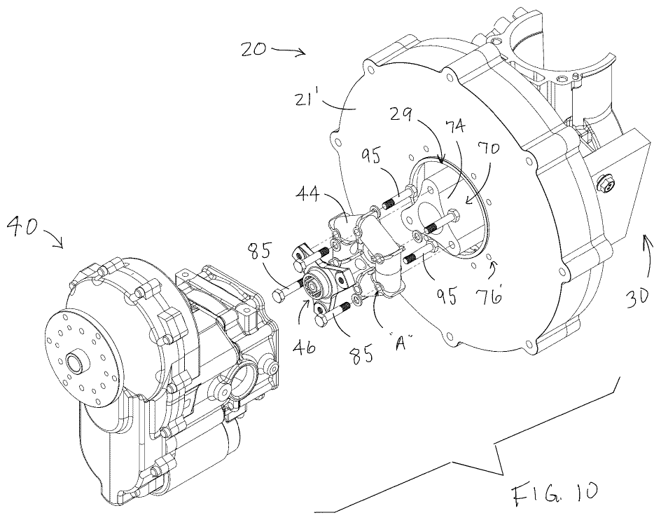

Adapter 20 further includes a flywheel hub 70 connected to the flywheel 24. Flywheel hub 70 connects the flywheel 24 to an engine drive shaft 34 of the engine 30 and simultaneously connects the drive shaft 34 (and flywheel 24) to a rubber coupling 44 of the gearbox 40 as described further below. Flywheel hub 70 includes a flange portion 72 having a disk-like feature extending outward and configured to connect to the flywheel 24. In one aspect fasteners 75, such as screws or bolts, are used to connect flywheel hub 70 to flywheel 24 by placing the fasteners 75 through the flange portion 72 at openings/threads 73 and into the openings/threads 73′ defined by field section 28. Flywheel hub 70 also includes base portion 74 which is configured to extend outward from a gearbox-side opening 29 of the first casing 21. Flywheel hub 70 in one aspect includes a tapered bore 71, or in some cases splines, configured to receive or mate with taper or splines of an engine drive shaft 34 which extends from the engine 30. Flywheel base 74 also includes fastener ports with threads and is configured to connect to rubber coupling 44 within gearbox 40, at a side of casing 20 opposite engine 30. See FIG. 3, FIG. 6. The base 74 extends outward from adapter 20 and into gearbox 40 where it is connected using fasteners 85 such as bolts or screws passing through rubber coupling 44 to base portion 74. As shown in FIG. 10, in one aspect a set of three fasteners 85 are used to secure rubber coupling 44 to flywheel hub 70 at base portion 74. Other fastening arrangements may be used. The base portion 74 and flange portion 72 are integrally formed as part of flywheel hub 70. In aspects flywheel hub 70 is made from metal such as steel or other metal or metal hybrid.

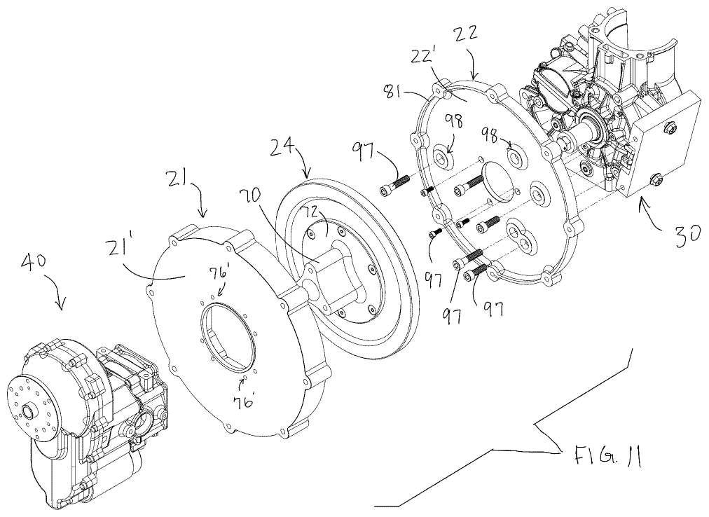

With reference to FIG. 11, adapter 20 is secured to engine 30 by inserting fasteners 97 such as bolts through openings at second casing portion 22 into engine 30. In aspects, second casing portion 22 of adapter 20 connects to engine 30 at pre-set bolt hole pattern defined by engine 30, with some fasteners 97 connected directly to engine block 32 and other fasteners 97 connected to other areas of engine 30. In aspects, the fasteners 97, or some of them, insert into reinforced openings 98 at casing portion 22. While flywheel hub 70 is positioned on drive shaft 34, first casing portion 21 is secured to second casing portion 22 passing bolts or other fasteners through faster ports 25.

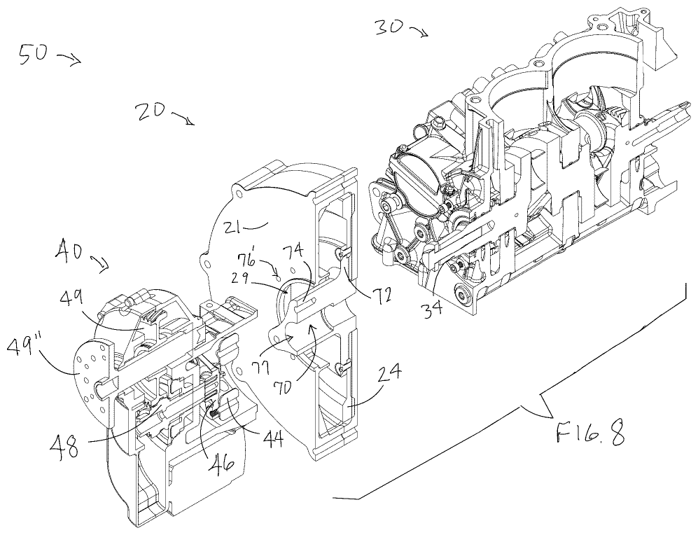

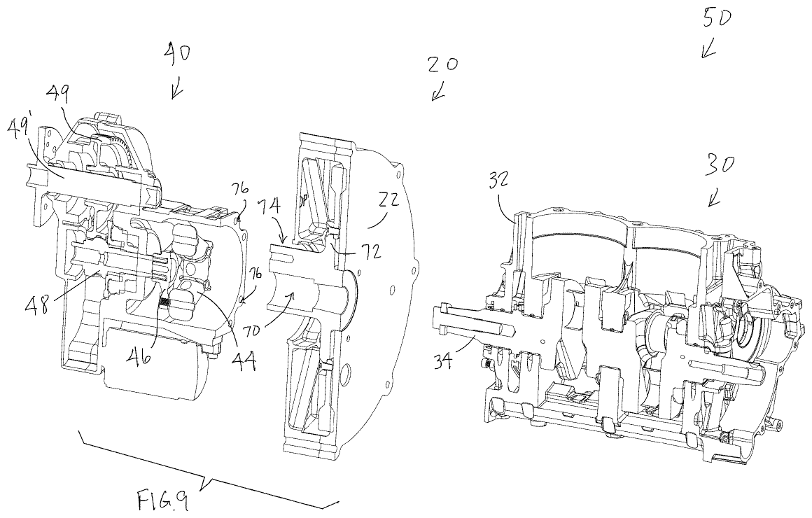

Gearbox 40 is connected to adapter 20 by securing fasteners such as bolts or screws through gearbox 40 into first casing portion 21. Fasteners such as bolts are secured through elongated ports 76 (extending longitudinally) in the housing of gearbox 40 (See FIG. 9) and into receiving ports 76′ defined by first casing portion 21 (See FIG. 8). The receiving ports 76′ are arranged in a pattern to match preset receiving ports 76 of gearbox 40 to accommodate use of off-the-shelf or common housings of a gearbox 40.

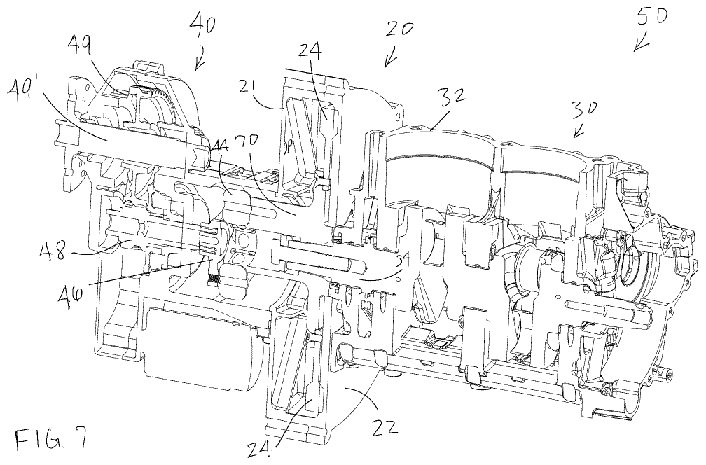

As shown in FIG. 3, FIG. 6 and FIG. 10, the rubber coupling 44 is connected to flywheel hub 70 by inserting fasteners 85 such as bolts into receiving ports “A” of rubber coupling 44 and into flywheel hub 70. A standard type of rubber coupling 44 traditionally used in gearbox applications, such as within the Rotax E device, may be used. Coupling 44 includes a set of three receiving ports “A” which accommodate insertion of three fasters 85 or bolts through the coupling 44 into the flywheel hub 70. Coupling 44 also includes a set of three receiving ports “B” which accommodate insertion of three fasteners 95 through rubber coupling 44 and into coupling flange 46 (See FIG. 10). The coupling flange 46 connects output drive 48 to rubber coupling 44. Output drive 48 includes teeth or threads or splines which engage with corresponding teeth or threads or splines of driven gear 49 (in one application of the invention, driven gear 49 is a propeller gear), which driven gear 49 in turn drives drive shaft 49′. In one application, a propeller 62 connects to the drive shaft 49′ via shaft flange 49″. FIG. 7 is a reverse angle perspective section view of the engine system showing the various components for clarity. In other applications shaft flange 49″ may be used for spinning a pump impeller or other component or machine to be driven. Spinning output drive 48 causes propeller 62 to also spin.

With reference to FIG. 8 and FIG. 9, the adapter 20, drive system and engine system 50 and components are shown in exploded section view. The adapter 20 is positioned between engine 30 having engine block 32 and gearbox 40. Second casing portion 22 connects the adapter to the engine block 32 with drive shaft 34 inserted into flywheel hub 70. Flywheel hub 70 connects to flywheel 24 within the casing 21, 22, and includes flywheel base portion 74 which extends from adapter 20 into gearbox 40 where it connects to rubber coupling 44. Casing 21, 22 is of narrow profile to accommodate a compact connection of the engine 30 to the gearbox 40.

The profile and dimension of flywheel 24 may vary according to the engineering needs of the system as needed to dampen vibration forces or otherwise allow the system to run smoothly (such as by balancing moments of inertia). As the diameter or thickness of flywheel 24 may be altered, so too may the dimensions of casing 21, 22. As the applicant of the invention varies, such as for powering a pump impeller or propeller of an aircraft, or propeller of a watercraft, etc., the dimensions of the flywheel 24 and adapter 20 may also vary to accommodate balanced moments of inertia in the systems.

In operation under one aspect of the invention, engine 30 is powered and selectively drives or spins engine drive shaft 34. Such spinning rotation powers flywheel hub 70 which in turn simultaneously spins both flywheel 24 and rubber coupling 44. Spinning of rubber coupling 44 causes rotation of output drive 48, via coupling flange 46, which in turn powers gear 49 and drive shaft 49′ and shaft flange 49″ to spin the propeller 62 to cause aircraft 60 to be propelled forward. The spinning of flywheel 24, which is a relatively large flywheel in comparison to the engine 30 and gearbox 40, accommodates dampening or smoothing of vibrations (or balancing of inner and outer moments of inertia) or otherwise operates to allow powering of propeller 62.

Flywheel 24 has a very large diameter in comparison to gearbox 40 and engine 30. Adapter 20, having such a large diameter flywheel 24 accommodates a greater variety of options for managing the vibrations and other aspects (including moments of inertia) of a variety of types of engines (and gearboxes). Engine systems in general can now be fitted with an appropriately sized (larger) flywheel to accommodate use of an engine in other applications, without the need to reconfigure an engine block or the housing of a typical gearbox. It may be appreciated that a 2-cylinder, 4-stroke engine, such as an engine used for a Polaris brand utility vehicle, or other type of engine, may be used for applications other than powering a gyroplane 60. The flywheel 24 may be specially designed to accommodate the variety of applications to make such engines compatible for use. The adapter 20 and flywheel 24 can be varied in size and used in conjunction with other engines to accommodate new uses or applications for such engines.

In aspects, center opening 26 of flywheel 24 has a diameter at least twice the diameter of the engine drive shaft 34 portion extending from the engine 30. Flywheel 24 also has an outer diameter 26′ (See FIG. 5) which diameter is greater than a total height “H” (See FIG. 3) of engine block 32 of engine 30. Outer diameter 26′ is also greater than a total diameter measure of gear 49 of gearbox 40. In aspects the outer diameter 26′ has a measure of between 8 and 16 inches. In one aspect the outer diameter 26′ measures 12 inches. The flywheel hub 70 has a center opening 77. In one aspect, the center opening 26 of flywheel 24 has a diameter at least twice the diameter of center opening 77 of flywheel hub 70. Such a large diameter flywheel 24 was not previously possible for use within a typical gearbox housing or for use within an engine block or engine housing given the large size constraints.

Such a large diameter flywheel 24, contained in its own casing 21, 22 connected to both the engine 30 and gearbox 40 has heretofore been unavailable for use with the gyroplane or other applications. The invention includes a large diameter flywheel 24 contained within a two-piece casing 21, 22, with a first portion of the casing 21 configured to connect to an engine 30 and a second portion 22 of the casing configured to connect to a gearbox 40. The two-piece casing 21, 22, accommodates fastening of the casing to the engine 30 and gearbox 40 by first allowing fastening of first casing portion 21 to the engine 30 by inserting fasteners such as bolts through the first casing portion into the engine block 32. In aspects, engine block 32 is configured as a single piece of metal which receives various engine components such as cylinders, shafts and bearings, among other components of the engine 30. After insertion of the flywheel 24, with connected flywheel hub 70 onto engine drive shaft 34, together with the remaining components of the gear box 40, gearbox 40 may be fastened to second casing portion 22. In a further aspect, the gearbox 40 is devoid of a flywheel contained within the gearbox housing itself.

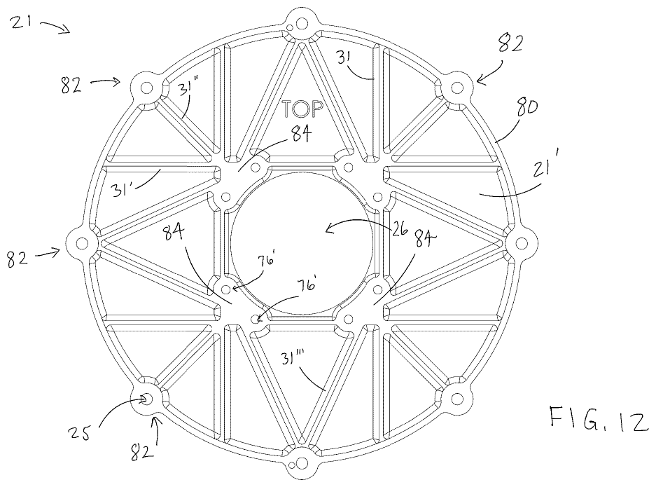

In a further aspect the invention includes a reinforced adapter 20 and reinforced casing portion 21 of the adapter 20. With reference to FIG. 5 and FIG. 12, first casing portion 21 includes a casing wall 21′ bounded by an edge wall 80. In one aspect edge wall 80 outlines a generally circular perimeter of casing portion 21. Casing wall 21′ defines central opening 26. Positioned at the edge wall 80 are a series of nodes 82 which define the fastener ports 25. The nodes 82 provide increased structural support about the perimeter edge wall 80, and align with corresponding notes 82 of the second casing portion 22 for securing together both portions 21, 22. Together the portions 21, 22 create a cavity in which the flywheel 24 is positioned. In one aspect the casing portion 21 includes eight nodes 82, and it may be appreciated that a different number of nodes may be utilized. Casing portion 21 further includes footings 84 positioned at a perimeter of central opening 26. In one aspect, a footing 84 is a reinforced member of thickened metal which projects inward from casing wall 21′. In one aspect a set of four footings 84 are used, and it may be appreciated that a different number of footings 84 may be used. Connected to footings 84 are ribs 31. The ribs 31 are reinforced members of thickened metal which project inward from casing wall 21′. Ribs 31 extend from footings 84 to each of the nodes 82 and to the edge wall 80. A set of vertical ribs 31, horizontal ribs 31′ and angled ribs 31″, 31′″, arranged to provide structural support for first casing portion 21. In some aspects the angled ribs 31″ are at a 45 degree angle with respect to the horizonal and vertical ribs, or the angled ribs 31′″are at a 30 or 60 degree angle with respect to the vertical or horizontal ribs. In one aspect, a footing 84 is combined with multiple ribs 31, 31′, 31″, 31′″ in a pattern to lend structural support to the casing portion 21. In one aspect the ribs 31 are arranged in truss-like orientation to provide structural integrity to the casing portion 21. The casing portion 21 is configured to receive the gearbox 40 by fastening the gearbox 40 to the casing portion 21 using bolts positioned through the receiving ports 76′ defined by the footings 84. In such arrangement, the forces impacting upon or through gearbox 40 are delivered directly to or at the footings 84, and such forces are distributed outward or radially toward the edge wall 80 and notes 82 by the ribs 31, 31′, 31″, 31′″ and casing wall 21′. Such forces include the thrust load imparted by the propeller 62 during operation, including any overhang load of the combined gearbox 40 and propeller 62. Each node 82 is connected to a footing 84 with at least one rib 31, 31′, 31″, or 31′″ and some nodes 82 and some footings 84 include multiple connecting ribs 31, 31′, 31″, or 31′″. In one aspect, each footing 84 includes seven connecting ribs, 31, 31′, 31″, or 31′″, and it may be appreciated that a different number of connecting ribs may be used. First casing portion 21 is connected to second casing portion 22 with fasteners passing into the nodes 82. The connected casing portions 21, 22 allow for the thrust forces to be passed to the engine 30 via connection of the second casing portion 22 to the engine block 32 and other components of engine 30. The footings 84, nodes 82 and ribs 31, 31′, 31″ and 31′″ allow the thrust forces from the propeller 62 to reach the engine 30 while bypassing the flywheel 24. In alternatives, first casing portion 21 may be constructed with a thickened casing wall 21′ (instead of with ribs or in addition to ribs) having a thickness the same as or similar to the thickness of the ribs. However, such thickened casing portion 21 would be heavy and expensive.

In a further aspect the invention includes a method of powering an output drive 48 of a gearbox. The method includes providing a coupling flange 46 to the output drive 48, where the coupling flange 46 is connected to a rubber coupling 44 which in turn is connected to a flywheel hub 70 of an adapter 20. The flywheel hub is connected to a flywheel 24 and to the engine drive shaft 34. The method further includes activating the engine 30 to power the output drive. The method may be used to power an output drive 48 of the gearbox 40 to power a variety of machines, including using the powered output drive 48 to spin a propeller 62 of a gyroplane 60.

It should be understood, of course, that the foregoing relates to exemplary embodiments of the invention and that modifications may be made without departing from the spirit and scope of the invention as set forth in the following claims.

1. An adapter for connecting an engine with a gearbox, the adapter comprising:
a casing having a first casing portion connected to a second casing portion and defining a flywheel cavity; and
a flywheel contained within the flywheel cavity;
whereby the second casing portion is configured to connect to the engine and the first casing portion is configured to connect to the gearbox.

2. The adapter of claim 1 further comprising a flywheel hub connected to the flywheel and extending outward from a gearbox-side opening of the first casing portion.

3. The adapter of claim 2 where the flywheel hub includes a tapered bore and is secured with a bolt to an engine drive shaft extending from the engine into the adapter, and where the flywheel hub is configured to extend from the casing into the gearbox to connect with a rubber coupling of the gearbox.

4. The adapter of claim 1 where the first casing portion and the second casing portion are made of metal, the flywheel hub includes a flange portion connected to the flywheel and an integral base portion connected to the rubber coupling, the flange portion having a maximum flange diameter, the base portion having a maximum base diameter, the maximum flange diameter being greater than the maximum hub diameter.

5. The adapter of claim 4 where the base portion extends outward from the casing while the flange portion is positioned within the cavity.

6. The adapter of claim 1 where the flywheel has a flywheel center opening having a first diameter, the base portion has a hub center opening having a second diameter, the first diameter being at least twice as great as the second diameter.

7. The adapter of claim 1 where the first casing portion is made of metal and includes a plurality of internal ribs extending from at least one footing to at least one node of the first casing portion.

8. The adapter of claim 1 where the first casing portion and the second casing portion are made of metal, the first casing portion fastened to the second casing portion with bolts.

9. A system for powering a propeller of a gyroplane, the system comprising the adapter of claim 1 connected to the gearbox at the first casing portion and connected to a 2-cylinder, 4-stroke engine at the second casing portion.

10. A system for powering a driven shaft, the system comprising:
an engine having an engine drive shaft;
a flywheel;
a gearbox having an output drive shaft configured to power the driven shaft, the gearbox including a rubber coupling; and
a flywheel hub connected to the flywheel, the flywheel hub connected to the rubber coupling, and the flywheel hub connected to the engine drive shaft;
whereby activation of the engine powers the driven shaft.

11. The system of claim 10 where the flywheel hub includes a tapered bore configured to receive the engine drive shaft at one side of the flywheel hub and where the rubber coupling is connected to the flywheel hub at an opposite side of the flywheel hub.

12. The system of claim 10 further comprising a casing having a first casing portion connected to a second casing portion to define a flywheel cavity for containing the flywheel, the first casing portion connected to the gearbox and the second casing portion connected to the engine.

13. The system of claim 10 where the engine is a 2-cylinder, 4-stroke engine.

14. The system of claim 10 further comprising a propeller connected to the driven shaft.

15. A gyroplane comprising a propeller connected to the driven shaft of the system of claim 10, and further comprising a free rotation rotor.

16. A gyroplane, comprising:
a pilot section having controls for operation of the gyroplane;
a mast configured to position an unpowered free rotation rotor above the pilot section;
a propeller;
a 2-cylinder, 4-stroke engine configured to power the propeller for forward thrust of the gyroplane;
a gearbox; and
an adapter which together with the gearbox transfers power from the engine to the propeller.

17. The gyroplane of claim 16 where the adapter includes a first casing portion connected to the gearbox and a second casing portion connected to the engine, the casing defining a cavity for housing a flywheel powered by the engine.

18. The gyroplane of claim 16 where the adapter includes a flywheel contained within a casing having a first casing portion and a second casing portion, the first casing portion connected to the gearbox, the second casing portion connected to the engine.

19. The gyroplane of claim 18 where the flywheel has a diameter, the engine includes an engine block in part defining the cylinders and having a maximum block height, the diameter being greater than the maximum block height.

20. The gyroplane of claim 16 where the flywheel has a diameter, the gearbox includes a rubber coupling having a maximum rubber coupling height, the diameter being greater than twice the maximum rubber coupling height.

21. The gyroplane of claim 16 where the adapter includes a flywheel connected to a flywheel hub, the flywheel hub extending from a casing of the adapter and into the gearbox.

22. The gyroplane of claim 21 where the flywheel hub includes a tapered bore configured to mate with a tapered engine drive shaft extending from the engine into the adapter.

23. The gyroplane of claim 16 where the gearbox includes a rubber coupling connected to a flywheel hub, the flywheel hub connected to a flywheel contained within the adapter.

24. A method for powering a driven shaft of an apparatus, the method comprising:
providing a driven shaft driven by an output drive of a gearbox, a coupling flange connected to the output drive, a rubber coupling connected to the coupling flange, a flywheel hub connected to the rubber coupling, the flywheel hub connected to a flywheel and to an output shaft of an engine; and
activating the engine to power the driven shaft.

25. The method of claim 24 where the output drive activates a propeller gear to drive a propeller of the apparatus.

26. An adapter for connecting an engine with a gearbox, the adapter comprising:
a casing having a first casing portion connected to a second casing portion and defining a flywheel cavity; and
a flywheel contained within the flywheel cavity;
whereby the second casing portion is configured to connect to the engine and the first casing portion is configured to connect to the gearbox.

27. The adapter of claim 26 further comprising a flywheel hub connected to the flywheel and extending outward from a gearbox-side opening of the first casing portion.

28. A drive system, comprising:
an engine having an engine block;
a gearbox having an output drive powered by the engine; and
an adapter having a first casing portion connected to a second casing portion and defining a flywheel cavity, a flywheel contained within the flywheel cavity;
the first casing portion connected to the gearbox, the second casing portion connected to the engine, the flywheel having a diameter greater than a total height of the engine block;
whereby activation of the engine powers the output drive.

29. The drive system of claim 28 further comprising a flywheel hub connected to the flywheel and extending outward from a gearbox-side opening of the first casing portion.

30. The drive system of claim 29 where the flywheel hub is connected to an engine drive shaft extending from the engine into the adapter and is further connected to a rubber coupling within the gearbox.

31. A drive system, comprising:
an engine;
a gearbox having a driven gear powered by the engine, the driven gear having a maximum diameter; and
an adapter having a first casing portion connected to a second casing portion and defining a flywheel cavity, a flywheel contained within the flywheel cavity;
the first casing portion connected to the gearbox, the second casing portion connected to the engine, the flywheel having a diameter greater than the maximum diameter of the driven gear;
whereby activation of the engine powers the driven gear.

32. The drive system of claim 31 further comprising a flywheel hub connected to the flywheel and extending outward from a gearbox-side opening of the first casing portion.

33. A process for assembling a drive system, the process comprising:
connecting a first casing portion of an adapter to an engine of the drive system, an output drive powered by the engine and extending through the first casing portion;
connecting a flywheel hub to the output drive at a flywheel hub opening of the flywheel hub, the flywheel hub connected to a flywheel; and
connecting a second casing portion of the adapter to the first casing portion, the flywheel hub extending through a gearbox side opening of the second casing portion.

34. The process of claim 33 further comprising connecting a rubber coupling to the flywheel hub.

35. The process of claim 34 further comprising connecting a coupling flange to the rubber coupling, the coupling flange powering an output drive of a gearbox.

36. The process of claim 33 further comprising connecting a gearbox to the second casing portion of the adapter.

37. The process of claim 33 where the first casing portion is connected to the engine prior to connecting the flywheel hub to the output drive.
